(19) United States
(12) Patent Application Publication
(10) Pub. No.: US 2002/0156941 A1
(43) Pub. Date: Oct. 24, 2002

(54) Scanner having passthrough input control

(76) Inventor: David Boll, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/837,686

(22) Filed: Apr. 18, 2001

(51) Int. Cl. G06F 3/00

(52) U.S. Cl. 710/5

(57) ABSTRACT

An apparatus for transferring commands includes a scanner including a first port and a second port coupled together through a communication bus, and control logic associated with the communication bus, the control logic configured to control the passage of data over the communication bus. The invention also includes a method for communicating commands from a keyboard to a scanner comprising the steps of connecting a scanner to a computer over a communication bus in the scanner, and connecting a keyboard to the communication bus, where the communication bus passes commands from the keyboard directly to the computer.

### BACKGROUND OF THE INVENTION

1. Field of the Invention

The present invention relates generally to electronic imaging devices, and, more particularly, to an electronic imaging device having a communication bus that can be connected to an input device. The electronic imaging device may receive commands directly from the input device and can pass the input device commands through to a computer connected to the electronic imaging device.

2. Related Art

Personal computers, scanners, printers and other electronic devices are becoming readily available to the average consumer. Such electronic devices are useful for developing documents, sending and retrieving electronic mail (when connected to the Internet), and printing documents. Scanners are becoming widely available and are useful for developing electronic representations of documents. Scanners are being developed to include greater processing power, functionality and now even include network access capability. For example, scanners now typically include display screens and multiple-input interface panels. Unfortunately, these interface panels are generally limited to simple “one-button” commands.

Furthermore, scanners now include capability that makes them similar to network communication devices (sometimes referred to as a “digital sending device,” or “digital sender”). Such digital senders are capable of, for example, communicating via email or facsimile. Unfortunately, most conventional scanners do not include input interfaces other than the limited interface panel as described above. However, the limited interface panel is not convenient for entering complex input commands, and most conventional scanners, therefore, do not include a mechanism for communicating complex input commands to the scanner.

### SUMMARY

In architecture, the invention is an apparatus for transferring commands, comprising a scanner including a first port and a second port coupled together through a communication bus, and control logic associated with the communication bus, the control logic configured to control the passage of data over the communication bus.

The invention can also be conceptualized as a method for communicating commands from a keyboard to a scanner, the method comprising the steps of connecting a scanner to a computer over a communication bus in the scanner, and connecting a keyboard to the communication bus, where the communication bus passes commands from the keyboard directly to the computer.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar scanner and computer system in which the pass-through keyboard feature of the invention resides.

FIG. 2 is a detailed schematic view illustrating the scanner of FIG. 1.

FIG. 3 is a flow diagram illustrating an example of the operation of the control logic of FIG. 2.

FIG. 4 is a flow diagram illustrating an example of the operation of the power supply logic of FIG. 2.

### DETAILED DESCRIPTION OF THE INVENTION

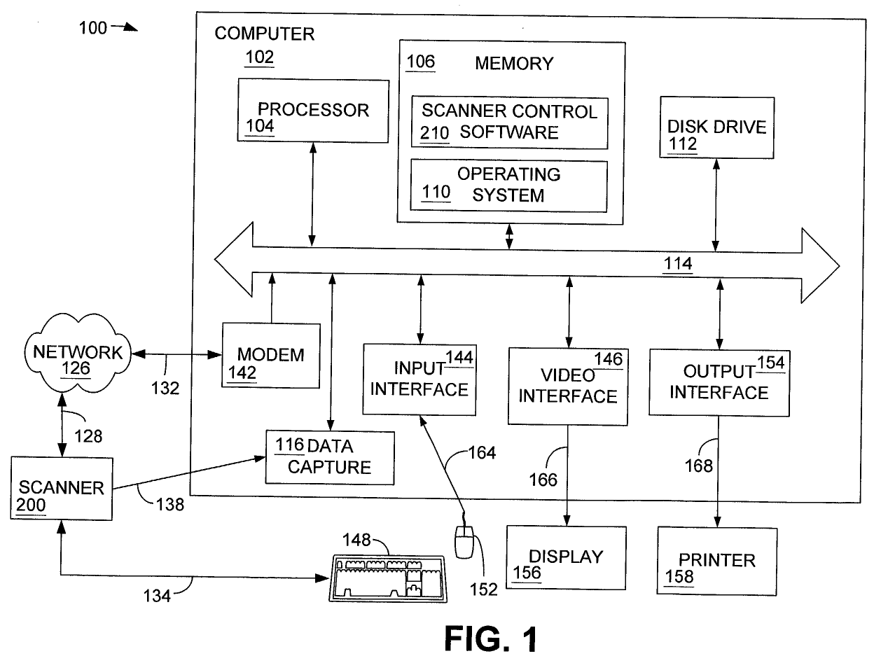

The scanner and pass-through keyboard apparatus of the invention can be implemented in software (e.g., firmware), hardware, or a combination thereof. In the currently contemplated best mode, the scanner and pass-through keyboard apparatus is implemented using a combination of hardware and software. The software portion of the invention is executed by a special or general purpose computer, such as a personal computer (PC; IBM-compatible, Apple-compatible, or otherwise), workstation, minicomputer, or mainframe computer. An example of a general purpose computer that can implement the software of the scanner and pass-through keyboard apparatus of the invention is shown in FIG. 1.

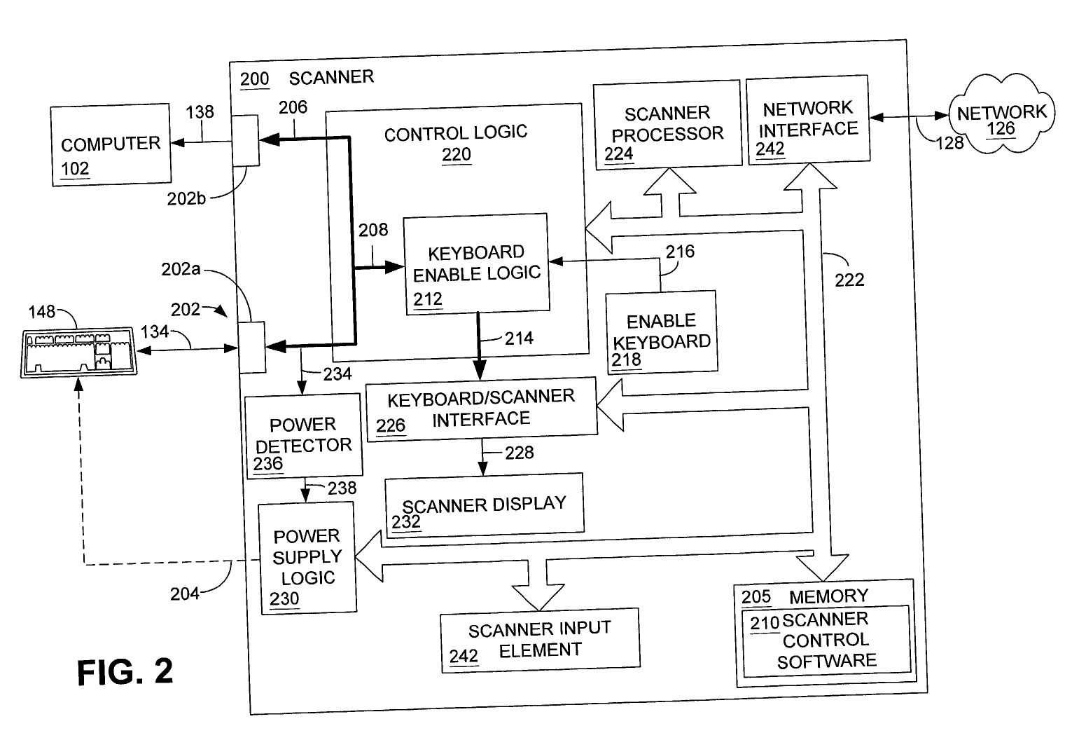

FIG. 1 is a block diagram illustrating an exemplar scanner and computer system 100 that includes a general purpose computer 102. The general purpose computer 102 can implement the scanner control software 210. The scanner control software 210 and other software and hardware elements (to be discussed with respect to FIG. 2) work in unison to implement the pass-through input device functionality of the invention. Generally, in terms of hardware architecture, as shown in FIG. 1, the computer 102 includes a processor 104, memory 106, a disk drive 112, an input interface 144, a video interface 146 and an output interface 154 that are connected together and can communicate with each other via a local interface 114. The local interface 114 can be, for example but not limited to, one or more buses or other wired or wireless connections, as is known in the art. The local interface 114 may have additional elements, which are omitted for simplicity, such as buffers (caches), drivers, and controllers, to enable communications. Further, the local interface 114 includes address, control, and data connections to enable appropriate communications among the aforementioned components.

The processor 104 is a hardware device for executing software that can be stored in memory 106. The processor 104 can be any custom made or commercially available processor, a central processing unit (CPU) or an auxiliary processor among several processors associated with the computer 102, and a microchip-based microprocessor or a macroprocessor. Examples of suitable commercially available microprocessors are as follows: a PA-RISC series microprocessor from Hewlett-Packard Company, an 80x86 or Pentium series microprocessor from Intel Corporation, a PowerPC microprocessor from IBM Corporation, a Sparc microprocessor from Sun Microsystems, Inc., or a 68xxx series microprocessor from Motorola Corporation.

The memory 106 can include any one or combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 106 may incorporate electronic, magnetic, optical, and/or other types of storage media. Note that the memory 106 can have a distributed architecture, where various components are situated remote from one another, but can be accessed by the processor 104.

The input interface 144 can receive commands from, for example, mouse 152 via connection 164 and transfer those commands over the local interface 114 to the processor 104 and the memory 106. In accordance with an aspect of the invention, keyboard 148 connects to the scanner 200 via connection 134. The scanner 200 connects to the data capture element 116 via connection 138. When an image is scanned, the electronic image data is transferred from the scanner 200 to the computer 102 via the data capture element 116. In accordance with an aspect of the invention, and to be described in detail below, keyboard commands are delivered from the keyboard 148, through the scanner 200 to the computer 102 via the data capture element 116.

The video interface 146 supplies a video output signal via connection 166 to the display 156. The display 156 can be a conventional CRT based display device, or can be any other display device, such as a liquid crystal display (LCD) or other type of display.

The output interface 154 sends printer commands via connection 168 to the printer 158. The modulator/demodulator (modem) 142 can be any communication device capable of connecting the computer 102 to an external network 126. The network 126 may be a wide area network (WAN) or local area network (LAN). The scanner 200 is connected to the network 126 via connection 128. When connected to the network 126, the scanner can be used to communicate with other devices (not shown) connected to the network. For example, as will be described in detail below, the keyboard 148 can be used to input an email address, a facsimile address, or other type of communication device identifier into the scanner 200 so that a scanned image can be transmitted directly from the scanner 200 to another device connected to the network 126.

The software in memory 106 may include one or more separate programs, each of which comprises an ordered listing of executable instructions for implementing logical functions. In the example of FIG. 1, the software in the memory 106 includes the scanner control software 210 and a suitable operating system (O/S) 110. A non-exhaustive list of examples of suitable commercially available operating systems 110 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 110 essentially controls the execution of other computer programs, such as the scanner control software 210, and provides scheduling, input-output control, file and data management, memory management, and communication control and related services. The processor 104 and operating system 110 define a computer platform, for which application programs, such as the scanner control software 210, in higher level programming languages are written. The scanner control software 210 includes the software that allows the computer 102 to communicate with and control the operations of the scanner 200. The scanner control software 210, portions of which are also stored and executed in the scanner 200, also includes the software portions of the pass-through input device feature of the invention.

If the computer 102 is a PC, the software in the memory 106 further includes a basic input output system (BIOS) (omitted for simplicity). The BIOS is a set of essential software routines that test hardware at startup, start the O/S 110, and support the transfer of data among the hardware devices. The BIOS is stored in ROM as that it can be executed when the computer 102 is activated.

When the computer 102 is in operation, the processor 104 is configured to execute software stored within the memory 106, to communicate data to and from the memory 104 and to generally control operations of the computer 102 pursuant to the software. The scanner control software 210 and the O/S 110, in whole or in part, but typically the latter, are read by the processor 104, perhaps buffered within the processor 104, and then executed.

When portions of the pass-through input device feature of the invention are implemented in software, as is shown in FIG. 1, it should be noted that the scanner control software 210 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The scanner control software 210 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the pass-through keyboard feature of the invention can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 2 is a detailed schematic view illustrating the scanner 200 of FIG. 1. For purposes of explaining the invention, a keyboard will be used as the input device connected to the scanner 200. However, other input devices, such as, for example, a mouse can be used. The scanner 200 includes an interface 202 through which the computer 102 and the keyboard 148 connect to the scanner 200. The keyboard 148 connects to the scanner 200 via interface 202a, and the computer 102 connects to the scanner 200 via interface 202b. The interfaces 202a and 202b will be collectively referred to as interface 202. The interfaces 202a and 202b also include ports through which the connections described above can be made. The interface 202 can be, for example, a universal serial bus (USB) interface, a wireless interface, or can be any other interface known to those having ordinary skill in the art and for connecting computer and peripheral devices. The interface 202 is connected internally within the scanner 200 via communication bus 206. Communication bus 206 can be any logical interface for connecting multiple ports within the scanner 200.

The scanner 200 includes a scanner processor 224, memory 205, control logic 220, keyboard/scanner interface 226, power supply logic 230, and scanner input element 242 connected over logical interface 222. The logical interface 222 may include various communication, signaling and interface connections to provide connectivity to the elements within the scanner 200. The scanner input element 242 can be the mechanism through which a document is scanned and transferred to electronic format using the scanner processor 224. The scanner processor 224 can be, for example, but not limited to, a microprocessor for executing the scanner control software 210 contained in memory 205. A network interface 242 is also connected to logical interface 222 to allow the scanner 200 to connect to an external network 126 via connection 128. The network 126 can be a local area network (LAN), such as an interoffice network, or can be a wide area network (WAN), such as the Internet.

The control logic 220 is connected to the communication bus 206 and thereby can monitor the signals being communicated along the communication bus 206. The control logic 220 also includes keyboard enable logic 212. The keyboard enable logic 212 determines when to divert keyboard activity from the communication bus 206 to the keyboard/scanner interface 226. The keyboard enable logic 212 can be controlled by, for example, an enable keyboard switch 218 via connection 216. The enable keyboard switch 218 can be a hard-wired switch on the surface of the scanner 200 and accessible by a user. Alternatively, the keyboard enable logic 212 can be controlled by user inputs. For example, the keyboard enable logic 212 can be controlled by a predetermined control character from the keyboard 148.

The keyboard/scanner interface 226 is connected to the scanner display 232 via connection228. The scanner display 232 can be, for example but not limited to, a liquid crystal display (LCD) interface for displaying various information, such as for example, scanner status to a user, and for displaying keystrokes entered using keyboard 148.

The scanner 200 includes power detector 236 connected to the communication bus 206 via connection 234, and includes power supply logic 230 connected to the power detector 236 via connection 238. In one aspect of the invention, and specifically when the computer 102 is not activated, the power supply logic 230 includes a power supply and directs power from the scanner 200 to the keyboard 148 via connection 204.

In accordance with an aspect of the invention, the keyboard 148 connects to the interface 202a via connection 134. Keystrokes from the keyboard are directed along communication bus 206 to interface 202b and out to the computer 102 via connection 138. In this manner, the scanner 200 passes keyboard commands through the scanner and to the computer 102.

In order to illustrate the operation of the invention, three different operational scenarios will be described. The first operational scenario is when the computer 102 and the scanner 200 are both activated and operating. When the computer 102 and the scanner 200 are both operating, it is desirable to direct the input from the keyboard 148 directly through the interface 202 via the communication bus 206 to the computer 102. This is a default condition and is entered automatically when the scanner 200 is activated and after each scan operation. Furthermore, when the scanner 200 and the computer 102 are both activated and operating, the computer 102 provides operating power to the keyboard 148 via the interface 202 and the communication bus 206.

In accordance with an aspect of the invention, there are instances when it is desirable to use the keyboard 148 to provide commands and/or input to the scanner 200. For example, when the scanner 200 is connected to a network 126 via the network interface 242, it would be possible for the scanner 200 to communicate directly with other network-connected devices without using the computer 102. For example, it is possible for the scanner 200 to scan a document and create an electronic file of the scanned image. This electronic file can be electronically transmitted (e.g., emailed or faxed) directly from the scanner to another network device via the network 126. In order to accomplish such functionality, it is desirable to enter commands directly to the scanner using the keyboard 148. In such an instance, the keyboard enable logic 212 overrides the default condition (communicating keyboard commands directly from the keyboard 148 to the computer 102 via the communication bus 206) and connects the communication bus 206 via connection 208 to the keyboard enable logic 212. The keyboard enable logic 212 receives the keyboard commands via connections 206 and 208 and directs the keyboard commands, via connection 214, to the keyboard/scanner interface 226.

The keyboard enable logic 212 can be activated by, for example, the enable keyboard button 218 via connection 216, or perhaps by a unique control character sent from the keyboard 148. In such an instance, the control logic 220 monitors the communication bus 206 for the unique control character that enables the keyboard. When the control character is recognized, the keyboard enable logic 212 reacts to that character and directs keyboard input to the keyboard/scanner interface 226.

When the keyboard enable logic 212 directs keyboard commands from the keyboard 148 to the keyboard/scanner interface 226, the keyboard/scanner interface 226 transfers those commands to the logical interface 222. For example, if the keyboard commands indicate that a user wishes to email a scanned image, the keyboard/scanner interface forwards the commands to the scanner processor 224. The scanner processor 224 invokes the necessary email program (not shown) and then forwards the command to the network interface 242. The keyboard/scanner interface 226 can also communicate with the scanner display 232 via connection 228 in order to display the commands received from the keyboard 148.

The second operating scenario is when the computer 102 is activated and running and the scanner 200 is off. In such a case, the computer 102 provides power to the keyboard 148 via the communication bus 206 as described above. In such an instance, the computer 102 and the keyboard 148 function as if the keyboard was connected directly to the computer 102.

The third operational scenario is when the computer 102 is off and the scanner 200 is activated and operating. In such an instance, it is desirable to use the keyboard 148 to provide commands to the scanner 200. In such an instance, the power detector 236 monitors the connection bus 106, via connection 234, and determines whether power is being supplied from the computer 102 to the keyboard 148. Because the computer is off, the power detector 236 determines that there is no power being supplied from the computer 102 to the keyboard 148. The power detector 236 then sends a signal to the power supply logic 230 via connection 238, so that the power supply logic 230 can supply power to the keyboard 148 via connection 204. In this manner, when the computer 102 is off, the scanner 200 provides power to the keyboard 148 so that the keyboard 148 can be used to send commands to the scanner 200.

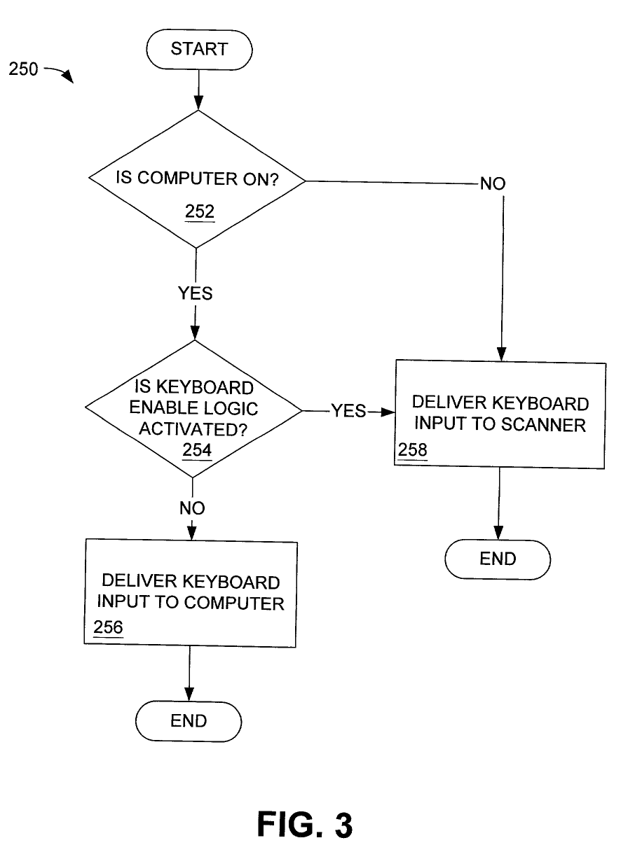

FIG. 3 is a flow chart 250 illustrating an example of the operation of the control logic 220 of FIG. 2. In block 252 the control logic 220 determines whether the computer 102 is operating. If the computer 102 is operating, then in block 254, the control logic 220 determines whether the keyboard enable logic 212 is activated.

If, in block 252, the control logic 220 determines that the computer is turned off, then, in block 258, the control logic 220 delivers keyboard input received on communication bus 206 to the keyboard/scanner interface 226 via the keyboard enable logic 212.

If, in block 254, the control logic 220 determines that the keyboard enable logic 212 is activated, then, in block 258, the keyboard commands are delivered to the keyboard/scanner interface 226. If, in block 254, it is determined that the keyboard enable logic 212 is disabled, then the control logic 220 delivers the keyboard input via communication bus 206 to the computer 102 in block 256.

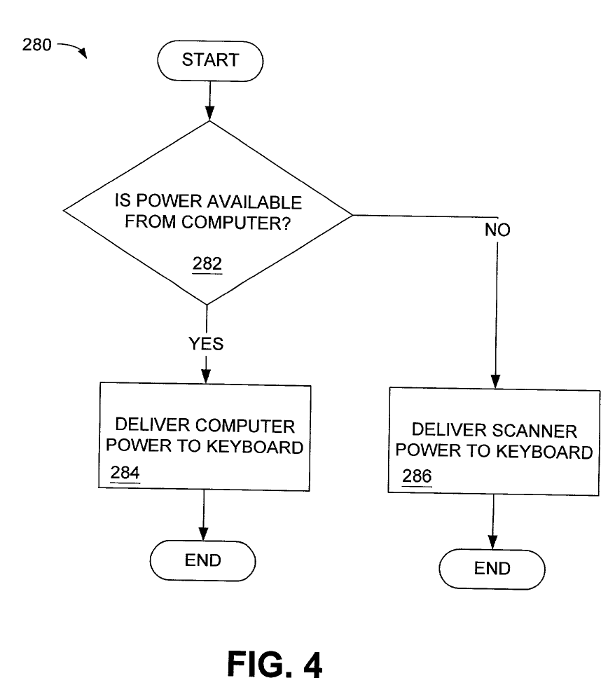

FIG. 4 is a flow diagram 280 illustrating an example of the operation of the power supply logic 230 of FIG. 2.

In block 282, the power detector 236 determines whether power is available from the computer 102 via the communication bus 206. If the power detector 236 determines that power is available through the computer 102, that power is delivered via the communication bus 206 to the keyboard 148 via connection 134.

If, in block 282, the power detector 236 determines that computer power is not available on communication bus 206, then, in block 286, the power supply logic 230 delivers power from the scanner 200 to the keyboard 148 via connection 204.

It will be apparent to those skilled in the art that many modifications and variations may be made to the preferred embodiments of the present invention, as set forth above, without departing substantially from the principles of the present invention. For example, the photo generation system can be used to print various image sizes regardless of the size of the input image. All such modifications and variations are intended to be included herein within the scope of the present invention, as defined in the claims that follow.

What is claimed is:

1. An apparatus for transferring commands, comprising:
a scanner including a first port and a second port coupled together through a communication bus; and
control logic associated with the communication bus, the control logic configured to control the passage of data over the communication bus.

2. The apparatus of claim 1, further comprising a keyboard coupled to the first port.

3. The apparatus of claim 1, further comprising:
a computer coupled to the second port, where the communication bus passes commands from the keyboard directly to the computer.

4. The apparatus of claim 2, wherein the control logic is configured to detect the presence of commands from the keyboard.

5. The apparatus of claim 4, wherein the control logic routes commands from the keyboard to the computer.

6. The apparatus of claim 2, further comprising keyboard enable logic associated with the control logic.

7. The apparatus of claim 6, wherein the keyboard enable logic instructs the control logic to route commands from the keyboard to a keyboard/scanner interface.

8. The apparatus of claim 2, further comprising a power detector coupled to the communication bus, the power detector configured to detect a power signal from the computer.

9. The apparatus of claim 8, further comprising power supply logic configured to supply power to the keyboard if the power detector fails to detect the power signal from the computer.

10. The apparatus of claim 7, wherein the keyboard/scanner interface is configured to receive keyboard commands from the control logic and forward the keyboard commands to a processor of the scanner.

11. The apparatus of claim 10, wherein the keyboard commands correspond to an email address.

12. The apparatus of claim 10, wherein the keyboard commands correspond to a facsimile address.

13. The apparatus of claim 7, further comprising a network interface module coupled to the keyboard/scanner interface, the network interface module configured to connect the scanner to an external network.

14. The apparatus of claim 13, wherein a document scanned by the scanner is electronically mailed over the external network.

15. A method for communicating commands from a keyboard to a scanner, the method comprising the steps of:
connecting a scanner to a computer over a communication bus in the scanner; and
connecting a keyboard to the communication bus, where the communication bus passes commands from the keyboard directly to the computer.

16. The method of claim 15, further comprising the step of detecting whether a power signal is being transmitted from the computer to the scanner.

17. The method of claim 16, further comprising the step of supplying power to the keyboard from the scanner if the power signal from the computer is not detected in the detecting step.

18. The method of claim 15, further comprising the step of detecting, within the scanner, the presence of commands from the keyboard.

19. The method of claim 18, further comprising the step of routing commands from the keyboard to the computer.

20. The method of claim 18, further comprising the step of routing commands from the keyboard to the scanner.

21. The method of claim 15, further comprising the steps of:
receiving keyboard commands from a scanner/keyboard interface associated with the communication bus; and
forwarding the keyboard commands to a processor of the scanner.

22. The method of claim 21, wherein the keyboard commands correspond to an email address.

23. The method of claim 21, wherein the keyboard commands correspond to a facsimile address.

24. The method of claim 21, further comprising the steps of:
coupling a network interface module to the keyboard/scanner interface; and
connecting the scanner to an external network.

25. The method of claim 24, further comprising the step of electronically mailing a document scanned by the scanner over the external network.
